(19) United States
(12) Patent Application Publication
(10) Pub. No.: US 2024/0303250 A1
(43) Pub. Date: Sep. 12, 2024

(54) CLOUD DATA REPLICATION

(71) Applicant: Kyndryl, Inc., New York, NY (US)

(72) Inventors: Aradhya A. ARADHYA, Bengaluru (IN); Sudiksha GOYAL, Bengaluru (IN); Geetika BANSAL, Bengaluru (IN); Rajashekar SRIRAMULA, Bangalore (IN); Venkat K. PANJANI, Bangalore (IN); Agilandeswari KANNAN, Bengaluru (IN)

(21) Appl. No.: 18/181,930

(22) Filed: Mar. 10, 2023

(51) Int. Cl. G06F 16/27; G06F 16/29

(52) U.S. Cl. CPC G06F 16/27; G06F 16/29

(57) ABSTRACT

A computer-implemented method includes: generating, by the computing device, a plurality of data blocks for a received block size; sharing, by the computing device, a time based universally unique identifier (UUID) for a first data block of the data blocks and an incremental time interval between each data block of the data blocks; finding, by the computing device, a time based UUID which corresponds with the requested data block; and sending, by the computing device, the time based UUID to a cloud site, the time based UUID corresponding with the requested data block.

### BACKGROUND

Aspects of the present invention relate generally to a system, method, and computer program for cloud data replication and, more particularly, to a system, method, and computer program for cloud data replication using block localization and a time space identification.

Data replication and/or data restore presents challenges in cloud environments. For example, all of storage and/or backup needs for enterprises may be consolidated and stored in a single location and/or data center such that all data for a customer will be located in a centralized place. In such a scenario, if a user wants to copy data from one cloud zone to another cloud zone, all data blocks must be copied from a source to a destination and stored.

Data replicators are used to move data from one zone to another zone within a cloud environment. For example, if data needs to be copied from one zone to another zone, all of the data blocks will need to be copied from a source to a destination and stored in backup storage. This, however, may result in data synchronization issues in the cloud environment.

### SUMMARY

In a first aspect of the invention, there is a computer-implemented method including: generating, by the computing device, a plurality of data blocks for a received block size; sharing, by the computing device, a time based universally unique identifier (UUID) for a first data block of the data blocks and an incremental time interval between each data block of the data blocks; finding, by the computing device, a time based UUID which corresponds with the requested data block; and sending, by the computing device, the time based UUID to a cloud site, the time based UUID corresponding with the requested data block.

In another aspect of the invention, there is a computer program product including one or more computer readable storage media having program instructions collectively stored on the one or more computer readable storage media. The program instructions are executable to: receive a time based universally unique identifier (UUID) which points to a first data block of a plurality of data blocks and an incremental time interval between each data block of the data blocks from a tenant; store the time based UUID which points to the first data block of the data blocks and the incremental time interval between each data block of the data blocks; and recover data using the time based UUID which points to the first data block of the data blocks and the incremental time interval between each data block of the data blocks.

In another aspect of the invention, there is system including a processor, a computer readable memory, one or more computer readable storage media, and program instructions collectively stored on the one or more computer readable storage media. The program instructions are executable to: receive a block size of a tenant who requests data replication for a requested data block; generate a plurality of data blocks for the received block size; share a time based universally unique identifier (UUID) for a first data block of the data blocks and an incremental time interval between each data block of the data blocks; find a time based UUID which corresponds with the requested data block; and send the time based UUID to a cloud site, the time based UUID corresponds with the requested data block. The plurality of data blocks are arranged in an ascending order.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a diagram of a cloud architecture in accordance with aspects of the invention.

FIG. 5 shows a data structure of a maximum combination of data blocks in accordance with aspects of the invention.

FIG. 6 shows a flowchart of a client site according to embodiments of the present invention.

FIG. 7 shows a flowchart of a cloud site according to embodiments of the present invention.

FIG. 8 shows an example of blocks of data according to embodiments of the present invention.

FIG. 9 shows an example of time space identification for the blocks of data in FIG. 8 according to embodiments of the present invention.

FIG. 10 shows another diagram of a cloud architecture according to embodiments of the present invention.

FIG. 11 shows an example of a spatial based identification according to embodiments of the present invention.

### DETAILED DESCRIPTION

Aspects of the present invention relate generally to a the system, method, and computer program for cloud data replication and, more particularly, to a the system, method, and computer program for cloud data replication using block localization and a time space identification. In embodiments, the system, method, and computer program product may provide for a different way of viewing data from a cloud centralization perspective. For example, in a cloud provider or a cloud site, time and space identification may be used with pointers to point to actual data for data replication; instead of using the actual data itself for data replication. Further, in embodiments, the system, method, and computer program product may use a data localization process and time space process to improve data replication speed in a cloud environment. In embodiments, the system, method, and computer program product may generate time space identification for changed data blocks and may send the generated time space identification instead of the changed data blocks. Further, in an example, the system, method, and computer product uses block localization and a time space process to identify unique blocks. Advantageously, it is now possible to, amongst other features, (i) save storage costs by reducing storage space needed for data backup, (ii) protect institutions from ransomware attacks, (iii) provide additional protections from data leaks since time based identification is not known by outside entities, (iv) speed up initial data synchronization, (v) meet recovery point objectives (RPO) even with network bandwidth limitations, (vi) adapt and cater to increasing storage demand, and (vii) reduce data risk, data corruption, and data leaks associated with transmitting data.

Implementations of the invention provide an improvement in the technical field of data replication by using data block localization and a time space process to improve data replication speed, storage demand, network consumption, and reduce the risk of data corruption and theft. In more specific embodiments, the data block localization may arrange multiple combinations of data for a specific block size and the time space process may use a time based universally unique identifier (UUID). Implementations of the invention also provide additional improvements in the technical field of data replication by generating time space UUIDs for changed data blocks and sending the time space UUIDs to a cloud site or a cloud provider to improve data replication speed, storage demand, network consumption, and reduce the risk of data corruption and theft. In particular, by using the time based UUID format, the time based UUIDs may point to actual data that needs to be replicated (i.e., have a pointer to all of the data blocks that need to be replicated). In addition, a checksum mechanism may be used on time based UUIDs to check a data integrity for the time based UUIDs.

Aspects of the present invention may include a system, method, and computer program product to replicate data between cloud zones using time based UUIDs. For example, the system, method, and computer program may replicate data between cloud zones by sorting all possible combinations of data for specific data blocks. The system, method, and computer program may also generate the time based UUIDs and associate the generated time based UUIDs with data blocks. The system, method, and computer program may replicate data between cloud zones by sending time space based UUIDs to a cloud site or a cloud provider instead of sending the actual data. The system, method, and computer program may encrypt the actual data using time space based UUIDs. The system, method, and computer program may decode the time space based UUIDs to data blocks and restore and/or retrieve the actual data. The system, method, and computer program may interpret data in data blocks and identify non-usable junk data blocks. The system, method, and computer program may generate the time space UUIDs based on a customer defined time for a first data block.

Moreover, aspects of the present invention include a system, method, and computer program product which uses data block localization and a time space method to identify unique data blocks. For example, the system, method, and computer program product may arrange multiple combinations of data for a specific block size and use a time based universally unique identifier (UUID) instead of the data. Accordingly, by using time based UUIDs instead of actual data in data replication, storage demand may be reduced by approximately 75%, network consumption may be reduced by approximately 80%, risk of data corruption and theft may be reduced, and an initial data sync may be much faster than known systems.

In addition, aspects of the present invention include a system, method, and computer program product which uses multiple combinations of data for a specific block size and a time based universally unique identifier (UUID). Accordingly, by using the time space UUIDs, data replication space may be reduced by six times, cyber-attacks may be reduced, network bandwidth utilization may be reduced by more than 70%, costs may be reduced for customers, recovery point objective (RPO) data may reach quicker at a destination, and storage in a cloud environment may be decreased in comparison to known systems.

Aspects of the present invention may also include a method, system, and computer program product for improving data replication in a cloud environment. In embodiments, by implementing the system, method, and computer program product herein, data replication in the cloud environment is faster than known systems. Accordingly, implementations of the invention provide an improvement (i.e., technical solution) to a problem arising in the technical field of data replication. In addition, implementations of the invention provide an improvement (i.e., technical solution) to a problem arising in the technical field of data replication by using a data localization method and a time spaced method.

According to an aspect of the invention, the system, method, and computer program product uses data localization and a time space process to replicate and restore data. For example, the computer-implemented method includes: receiving a block size of a tenant who requests data replication for a requested data block; generating a plurality of data blocks for the received block size; sharing a time based universally unique identifier (UUID) for a first data block of the data blocks and an incremental time interval between each data block of the data blocks with a provider; finding a time based UUID which corresponds with the requested data block; and sending the time based UUID to a cloud site or a cloud provider which corresponds with the requested data block to the provider. In another example, the computer-implemented method includes: receiving a time based universally unique identifier (UUID) for a first data block of a plurality of data blocks and an incremental time interval between each data block of the data blocks from a tenant; storing the time based UUID for the first data block of the data blocks and the incremental time interval between each data block of the data blocks in a safe place; and recovering data using the first data block of the data blocks and the incremental time interval between each data block of the data blocks.

It should be understood that, to the extent implementations of the invention collect, store, or employ personal information provided by, or obtained from, individuals (for example, cloud data associated with a tenant), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

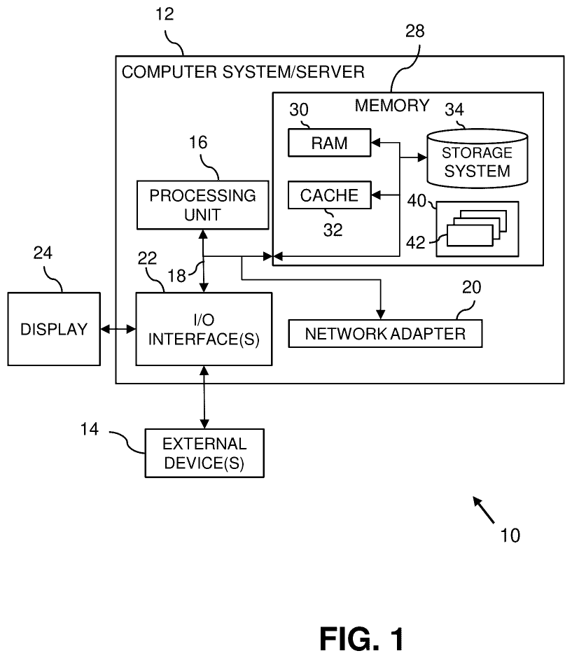

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

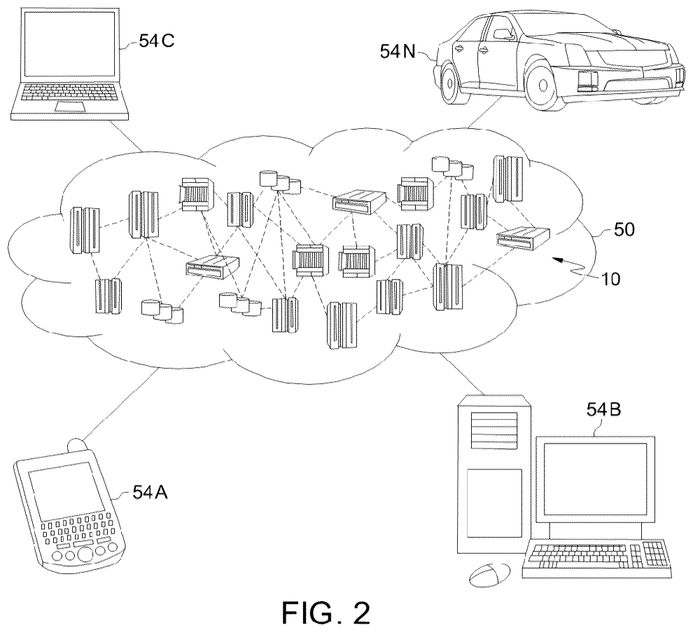

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

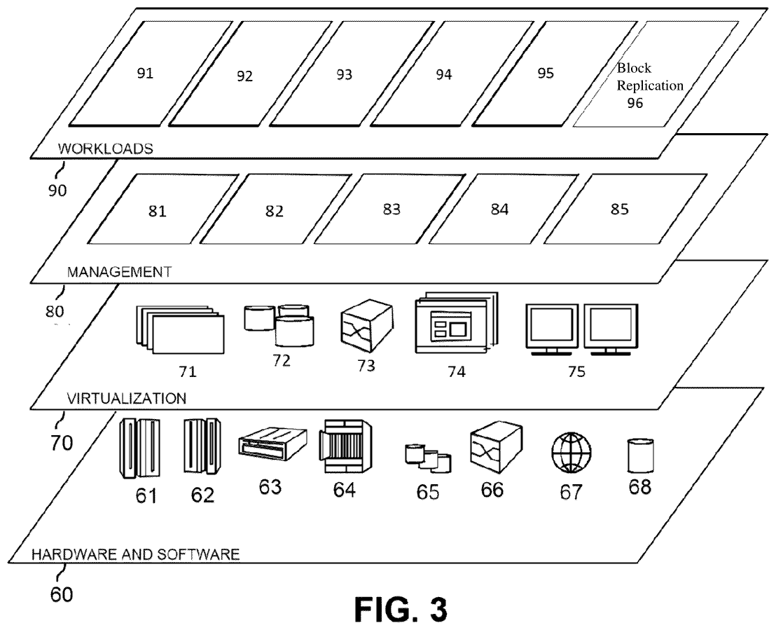

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and block replication 96.

Implementations of the invention may include a computer system/server 12 of FIG. 1 in which one or more of the program modules 42 are configured to perform (or cause the computer system/server 12 to perform) one of more functions of the block replication 96 of FIG. 3. For example, the one or more of the program modules 42 of the block replication 96 may be configured to get a block size of a tenant who wants to replicate; generate multiple combinations of data for the given block size; arrange the data in an ascending order; generate a time based universally unique identifier (UUID) for a first block; generate an incremental interval time for a second block UUID; share a first block's time based UUID and the incremental interval time with a cloud vendor; ask (i.e., request) the cloud vendor to store the first block's time based UUID and the incremental interval time as a key in a safe place; take a block and find a time based UUID corresponding to the block and send the time based UUID corresponding to the block when data is to be sent; and store the time based UUID in a cloud.

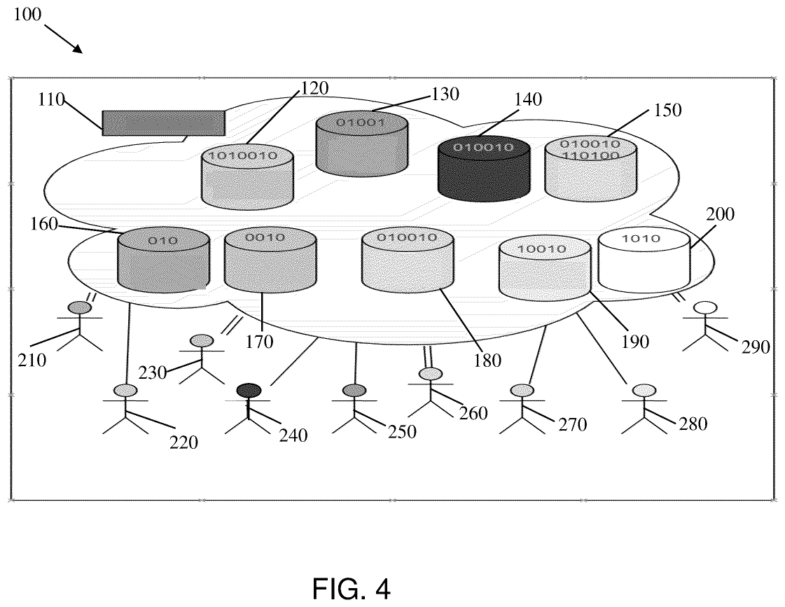

FIG. 4 shows a diagram of a cloud architecture in accordance with aspects of the invention. In embodiments, the cloud architecture 100 includes a cloud network 110 which includes virtual storages 120, 130, 140, 150, 160, 170, 180, 190, and 200, and tenants 210, 220, 230, 240, 250, 260, 270, 280, and 290. In the cloud network 110, each of the virtual storages 120, 130, 140, 150, 160, 170, 180, 190, and 200 may include at least one data block. For example, the virtual storage 120 may include at least one data block which comprises “1010010” and may be used for data needs of a corresponding tenant (i.e., a user or a customer who needs virtual storage for their data needs). In embodiments, (i) virtual storage 120 may correspond with tenant 220, (ii) virtual storage 130 may correspond with tenant 250, (iii) virtual storage 140 may correspond with tenant 240, (iv) virtual storage 150 may correspond with tenant 270, (v) virtual storage 160 may correspond with tenant 210, (vi) virtual storage 170 may correspond with tenant 230, (vii) virtual storage 180 may correspond with tenant 260, (viii) virtual storage 190 may correspond with tenant 280, and (ix) virtual storage 200 may correspond with tenant 290.

In embodiments of the cloud architecture 100, a data structure may be created to generate multiple combinations of data blocks (i.e., a plurality of data blocks) for a predetermined block size. As the multiple combinations of data blocks for the predetermined block size are arranged in a specific order (e.g., ascending order), a time based universally unique identifier (UUID) may be generated for a first data block of the multiple combinations of data blocks. An incremental interval of time may also be generated for a next block UUID (i.e., a second block UUID after the first data block UUID). Then, a time based UUID for the first data block and the incremental interval of time may be stored in the corresponding virtual storage to enable data replication. By storing the time based UUID and the incremental interval of time in corresponding virtual storage, storage demand may be reduced, network consumption may be reduced, data synchronization may be faster, and a risk of data corruption and theft may be reduced in comparison to known systems in which data is transmitted over a cloud architecture. In the example of the cloud architecture 100, when a tenant (e.g., tenant 210) requests data replication, the virtual storage (e.g., virtual storage 160) will provide replicated data based on the time based UUID for the first data block and the incremental interval of time.

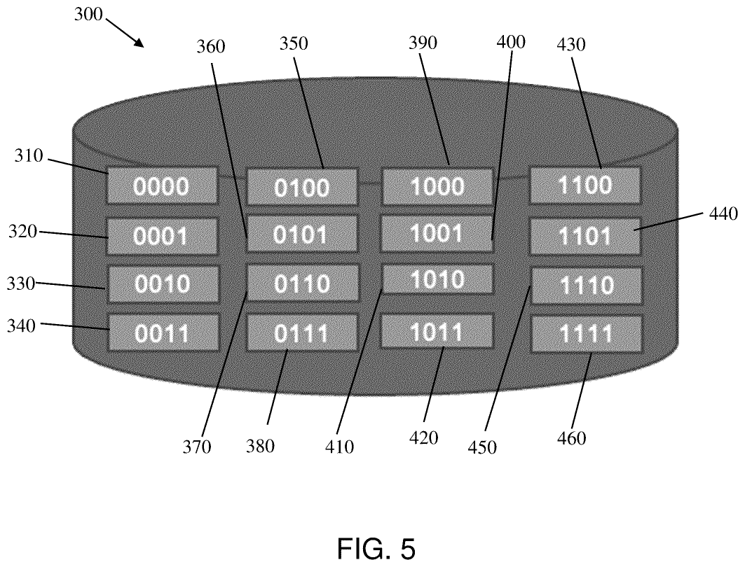

FIG. 5 shows a data structure of a maximum combination of data blocks in accordance with aspects of the invention. For example, FIG. 5 shows a data structure 300 of a four bit block, which can generate sixteen combinations of data blocks (i.e., the maximum combinations of data blocks). In the data structure 300, the different combination of data blocks are arranged in ascending order. For example, data block 310 is “0000”, data block 320 is “0001”, data block 330 is “0010”, data block 340 is “0011”, data block 350 is “0100”, data block 360 is “0101”, data block 370 is “0110”, data block 380 is “0111”, data block 390 is “1000”, data block 400 is “1001”, data block 410 is “1010”, data block 420 is “1011”, data block 430 is “1100”, data block 440 is “1101”, data block 450 is “1110”, and data block 460 is “1111”. It should be understood by those of skill in the art, though that embodiments are not limited to an ascending order, and may be differently ordered (e.g., descending order, spatial ordering, etc.). Further, although the data structure 300 shows a four bit block with sixteen combinations of data, other combinations are also contemplated herein, e.g., the data structure 330 may have “n” bit block (n being an integer value) with 2\hat{ }n maximum combinations of data blocks.

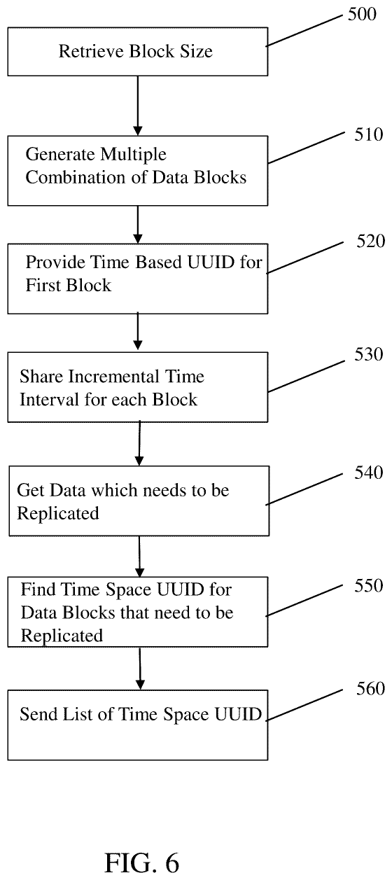

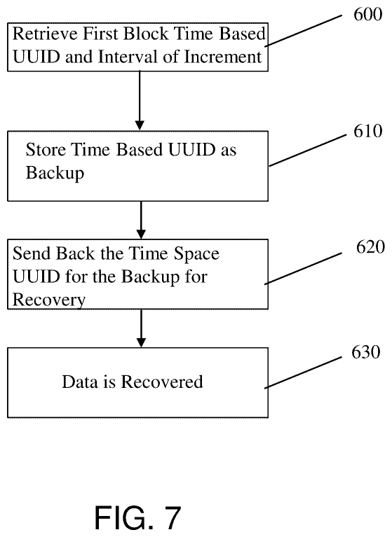

In embodiments, for the data structure 300, a time based universally unique identifier (UUID) may be generated for the first data block (i.e., data block 310). For example, the time based UUID generated for the first data block 310 may be “Jan. 5, 2023 at Noon”. Further, there may be an incremental interval of time between the first data block 310 and second data block 320. In this example, the interval may be one minute; although other intervals are also contemplated herein. Thus, the time based UUID generated for the second data block (i.e., data block 320) may be “Jan. 5, 2023 at 12:01 PM”. For the third data block (i.e., data block 330), the time based UUID generated may be “Jan. 5, 2023 at 12:02 PM”. The same process may be used for generating time based UUIDs for the remaining data blocks. In this way, the incremental interval of time between every sequential data block in ascending order may be one minute. Therefore, instead of using actual data in known systems, time based UUIDs for data blocks in an ascending order may be used to keep track of changed data when data needs to be replicated in a cloud environment. The details of the flowcharts for data recovery from a client site perspective and a cloud site perspective will be discussed in FIGS. 6 and 7, respectively.

FIG. 6 shows a flowchart of a client site according to embodiments of the present invention. In FIG. 6, in step 500, a block size may be retrieved for an application and/or tenant who wants data replication. In step 510, a data structure including multiple combinations of data blocks for the retrieved block size may be generated. In particular, the client may define the arrangement (i.e., order) of the multiple combinations of data blocks. For example, the arrangement (i.e., order) may be in ascending order, descending order, or a spatial ordering. It is understood, though, that the client may define a different arrangement of the multiple combinations of data blocks. In step 520, a time based UUID may be provided for a first data block of the multiple combinations of data blocks. In other embodiments, the time based UUID for the first data block of the multiple combinations of data blocks may be shared with a cloud provider or cloud site.

Still referring to FIG. 6, in step 530, an incremental time interval for each block is shared with the cloud provider or the cloud site. In embodiments, the incremental time interval may include a unit of time which separates the time based UUIDs between sequential data blocks. In embodiments, the incremental time interval may be seconds, microseconds, nanoseconds, minutes, hours, etc. In further embodiments, a request may be made to the cloud provider or the cloud site to store the time based UUID in a safe place (i.e., a safe place which is hard to access by another entity besides the client and/or tenant and the cloud provider and/or cloud site) for the first data block and an incremental time interval between each block. In step 540, data that needs to be replicated is received.

In step 550, the time based UUIDs are found for all of the data blocks that need to be replicated. In step 560, a list of time based UUIDs are sent for all of the data blocks that need to be replicated. In particular, the list of time based UUIDs are sent with pointers to all of the data blocks that need to be replicated (i.e., pointers are created for pointing the time based UUIDs to all of the data blocks that need to be replicated). In contrast, known systems would merely send actual data for replication. Thus, by sending a list of time based UUIDs which point to data blocks that need to be replicated, it is now possible to reduce data replication space, reduce cyber-attacks, reduce network bandwidth utilization, reduce costs, receive faster recovery point objective (RPO) data at a destination, and decreased storage in a cloud environment in comparison to known systems.

FIG. 7 shows a flowchart of a cloud site according to embodiments of the present invention. In FIG. 7, in step 600, the first data block time based UUID and the incremental time interval are received and saved as a master key. In step 610, when the customer sends the time based UUIDs for a backup, the cloud site stores the time based UUIDs, which correspond to the backup. In step 620, when a customer wants to recover (i.e., recover back to the backup), the time based UUIDs which correspond to the backup may be sent back to the customer. In step 630, when a customer wants the data to be recovered, the cloud site may use the first data block time based UUID and the incremental time interval (i.e., the master key) to recover the data. Accordingly, in FIG. 7, the cloud site may recover a backup or a data by only using the master key which includes time based UUIDs and the incremental time interval.

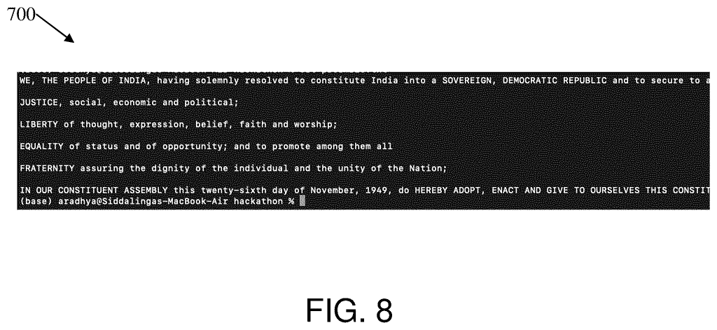

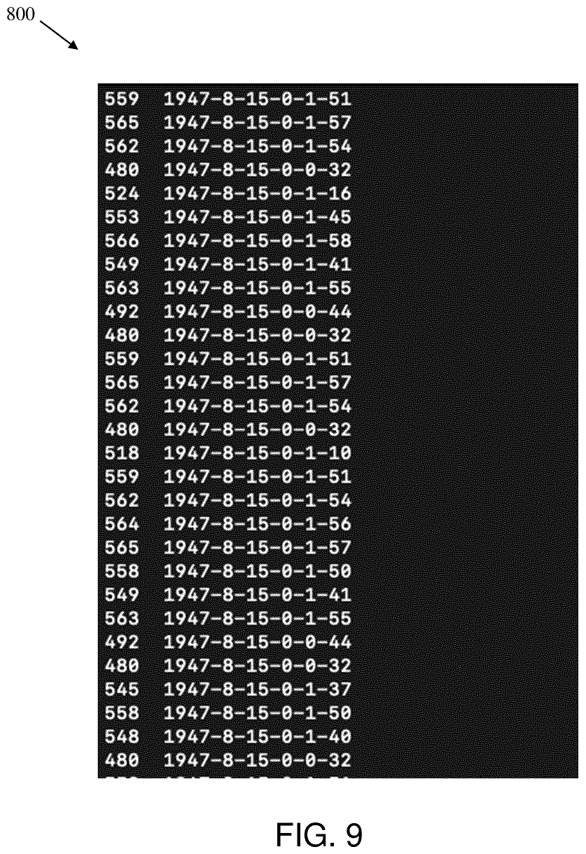

FIG. 8 shows an example of blocks of data according to embodiments of the present invention. In particular, the example 700 of blocks of data comprises ten blocks. In this scenario, the ten blocks in the example 700 may correspond with 32 time space based UUIDs (as described further in FIG. 9).

FIG. 9 shows an example of time space identification for the blocks of data in FIG. 8. In particular, the example 800 includes 32 time space based universally unique identifier (UUIDs). In contrast to time based UUIDs with only one dimension of time, time space based UUIDs have dimensions of both time and space included in the UUID. In embodiments time based UUIDs may also have multiple dimensions. In embodiments, the time space based UUIDs may be read from the example 800 to create a list of time space based UUIDs. Further, by using the list of time space based UUIDs, blocks of data may retrieved and built together to restore the data in a cloud environment.

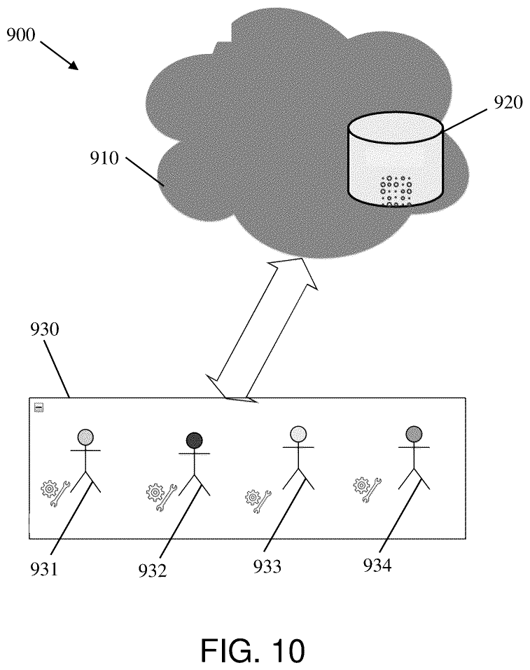

FIG. 10 shows another diagram of a cloud architecture according to embodiments of the present invention. In this embodiment, the cloud architecture 900 includes a cloud network 910 which includes virtual storage 920 and tenant group 930. In embodiments, the tenant group 930 may include tenants 931, 932, 933, and 934. In the cloud network 910, the virtual storage 920 may include at least one data block. For example, the virtual storage 920 may include at least one data block and may be used for data needs of all of the tenants in the tenant group 930 (e.g., tenants 931, 932, 933, and 934). In particular, the single virtual storage 920 may provide data needs for all of the tenants in the tenant group 930 (e.g., tenants 931, 932, 933, and 934).

In embodiments of the cloud architecture 900, a data structure may be created to generate multiple combinations of data blocks for a predetermined block size. As the multiple combinations of data blocks for the predetermined block size are arranged in a specific order (e.g., ascending order), a time based UUID may be generated for a first data block of the multiple combinations of data blocks. An incremental interval of time may also be generated for a next block UUID (i.e., a second block UUID after the first data block UUID). Then, a time based UUID for the first data block and the incremental interval of time may be stored in the virtual storage 920 to enable data replication. In the example of the cloud architecture 900, when a tenant (e.g., tenant 931) requests data replication, the virtual storage 920 will provide replicated data based on the time based UUID for the first data block and the incremental interval of time. By storing the time based UUID and the incremental interval of time in the virtual storage 920, storage demand may be reduced, network consumption may be reduced, data synchronization may be faster, and a risk of data corruption and theft may be reduced in comparison to known systems.

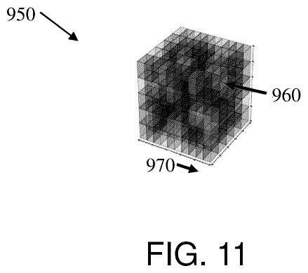

FIG. 11 shows an example of a spatial based identification according to embodiments of the present invention. In embodiments, the spatial based data structure 950 may include a data value 960 and a time 970 along the x-axis. The spatial based data structure 950 may include the different combinations of data (similar to the data structure 300 in FIG. 3). In embodiments, the spatial based data structure 950 may include both a time component and a spatial component, whereas the data structure 300 in FIG. 5 may only include the time component. The geospatial coordinates of each data block in the spatial based data structure 950 may help to define the arrangement of each data block so that a spatial UUID and an incremental interval of time can be used to recover and/or replicate data. Although the spatial based data structure 950 in FIG. 11 is shown as a three dimensional cube, other shapes for the data structure may be contemplated, such as spheres, cylinders, pyramid, prisms, etc. Also, in embodiments, a 4D shape may be used instead of a 2D or 3D shape.

In embodiments of FIG. 11, for the spatial data structure 950, a spatial based UUID may be generated for the first data block. For example, the spatial based UUID generated for the first data block may comprise “Jan. 5, 2023 at Noon” at geospatial position (X, Y) of “0, 0”. Further, there may be an incremental interval of time between the first data block and a second data block. In this example, the interval may be one minute. Thus, the spatial based UUID generated for the second data block may be “Jan. 5, 2023 at 12:01 PM” at geospatial position (X,Y) of “1, 0”. For the third data block, the spatial based UUID generated may be “Jan. 5, 2023 at 12:02 PM” at geospatial position (X,Y) of “2, 0”. The same process may be used for generating spatial based UUIDs for the remaining data blocks. Therefore, instead of using actual data as in known systems, spatial based UUIDs for data blocks may be used to keep track of changed data when data needs to be replicated or restored in a cloud environment. In the examples above, as spatial based UUIDs of FIG. 11 may include components of both time and space, these spatial based UUIDs may also be referred to as time space based UUIDs with multiple dimensions.

In embodiments, a service provider could offer to perform the processes described herein. In this case, the service provider can create, maintain, deploy, support, etc., the computer infrastructure that performs the process steps of the invention for one or more customers. These customers may be, for example, a business that tracks worker safety and provides health remediation to improve worker safety. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating, by the computing device, a plurality of data blocks for a received block size;
sharing, by the computing device, a time based universally unique identifier (UUID) for a first data block of the data blocks and an incremental time interval between each data block of the data blocks;
finding, by the computing device, a time based UUID which corresponds with the requested data block; and
sending, by the computing device, the time based UUID to a cloud site, the time based UUID corresponding with the requested data block.

2. The method of claim 1, wherein the sharing of the time based UUID is with the cloud site.

3. The method of claim 1, wherein the plurality of data blocks comprises a maximum combination of data blocks for the received block size.

4. The method of claim 1, wherein the plurality of data blocks are arranged in a predetermined order.

5. The method of claim 4, wherein the predetermined order comprises an ascending order for the plurality of data blocks.

6. The method of claim 1, wherein the incremental time interval comprises a unit of time which separates the time based UUIDs between sequential data blocks of the data blocks.

7. The method of claim 1, further comprising:
pointing, by the computing device, the time based UUID to the requested data block; and
sending, by the computing device, the time based UUID which points to the requested data block to the cloud site.

8. The method of claim 1, further comprising requesting, by the computing device, to store the time based UUID for the first data block and an incremental time interval between each block.

9. The method of claim 1, wherein the plurality of data blocks for the received block size are stored in a data structure.

10. The method of claim 1, wherein the time based UUID of the first data block comprises a geospatial coordinate within a data structure.

11. The method of claim 10, wherein the data structure comprises a three dimensional shape.

12. A computer program product comprising one or more computer readable storage media having program instructions collectively stored on the one or more computer readable storage media, the program instructions executable to:
receive a time based universally unique identifier (UUID) which points to a first data block of a plurality of data blocks and an incremental time interval between each data block of the data blocks from a tenant;
store the time based UUID which points to the first data block of the data blocks and the incremental time interval between each data block of the data blocks; and
recover data using the time based UUID which points to the first data block of the data blocks and the incremental time interval between each data block of the data blocks.

13. The computer program product of claim 12, wherein the plurality of data blocks comprises a maximum combinations of data blocks for a block size of the tenant.

14. The computer program product of claim 12, wherein the plurality of data blocks are arranged in a predetermined order.

15. The computer program product of claim 14, wherein the predetermined order comprises an ascending order for the plurality of data blocks.

16. The computer program product of claim 12, wherein the incremental time interval comprises a unit of time which separates the time based UUIDs between sequential data blocks of the data blocks.

17. The computer program product of claim 12, further comprising creating a pointer which points the time based UUID to the first data block for recovering the data.

18. The computer program product of claim 12, wherein the plurality of data blocks for the received block size are stored in a data structure.

19. The computer program product of claim 12, wherein the time based UUID of the first data block comprises a geospatial coordinate within a data structure.

20. A system comprising:
a processor, a computer readable memory, one or more computer readable storage media, and program instructions collectively stored on the one or more computer readable storage media, the program instructions executable to:
receive a block size of a tenant who requests data replication for a requested data block;
generate a plurality of data blocks for the received block size;
share a time based universally unique identifier (UUID) for a first data block of the data blocks and an incremental time interval between each data block of the data blocks;
find a time based UUID which corresponds with the requested data block; and
send the time based UUID to a cloud site, the time based UUID corresponds with the requested data block,
wherein the plurality of data blocks are arranged in an ascending order.
